(19) United States
(12) Patent Application Publication
(10) Pub. No.: US 2024/0118387 A1
(43) Pub. Date: Apr. 11, 2024

(54) METHOD AND APPLICATION OF FLASH IMAGING LIDAR FOR MEASURING ATTENUATION COEFFICIENT OF WATER BODIES

(71) Applicant: Harbin Institute of Technology (Weihai), Weihai (CN)

(72) Inventors: Zhaoshuo TIAN, Weihai (CN); Gang YANG, Weihai (CN); Zongjie BI, Weihai (CN); Zihao CUI, Weihai (CN); Ling WANG, Weihai (CN); Ke YANG, Weihai (CN); Liankun LIU, Weihai (CN)

(73) Assignee: Harbin Institute of Technology (Weihai), Weihai (CN)

(21) Appl. No.: 18/219,124

(22) Filed: Jul. 7, 2023

(30) Foreign Application Priority Data
Sep. 29, 2022 (CN) 202211204456.0

(51) Int. Cl. G01S 7/48; G01S 7/481; G01S 17/89

(52) U.S. Cl. CPC G01S 7/4802; G01S 7/4814; G01S 17/89

(57) ABSTRACT

A method and application of flash imaging lidar to measure the attenuation coefficient of water bodies are provided. In this novel method, the real time remote measurements are achieved on the attenuation coefficient of fresh water using flash imaging lidar based on the adjacent frame difference (AFD) method and water body backscattering model. The method solves the problems of low accuracy and high error of data obtained from real-time remote sensing measurement of attenuation coefficients of water bodies in the prior art; the slow speed of measurement data obtained when measuring water bodies, and the poor feasibility and reliability effect of the remotely measured attenuation coefficients of water bodies obtained. The experimental and theoretical analyses fully illustrate the feasibility of real-time remote sensing measurement of the attenuation coefficient of water bodies using the AFD method, which has a strong practical value.

### CROSS REFERENCE TO THE RELATED APPLICATIONS

This application is based upon and claims priority to Chinese Patent Application No. 202211204456.0, filed on Sep. 29, 2022, the entire contents of which are incorporated herein by reference.

### TECHNICAL FIELD

The present invention belongs to the technical field of water body transmittance data identification, and especially relates to the method and application of flash imaging lidar to measure the attenuation coefficient of water bodies.

### BACKGROUND

Water transmittance is a common index to evaluate the water environment. An important parameter to quantify the water transmittance is the attenuation coefficient of the water body, and at the same time, the attenuation coefficient of the water body is an important parameter for underwater detection by LIDAR systems, which characterizes the basic properties of the water body and determines the spectral characteristics of the light field transmitted in the water. Therefore, it is particularly important to measure the attenuation coefficient of the water body accurately and effectively in real time.

The directly method to measure the attenuation coefficient of water bodies is Beer-Lambert Law. Other methods to measure the attenuation coefficient of water bodies such as by measuring its Raman scattering, through the stimulated Brillouin scattering, and measuring its apparent optical properties. Although the Beer-Lambert Law is more accurate within a certain range, it requires the sampling of test water which makes it difficult to be performed remotely.

Through the above analysis, the problems and defects of the prior technology are:
(1) The data obtained from real-time remote sensing measurements of attenuation coefficients of water bodies in the prior art are of low accuracy and high error.
(2) The laser imaging radar equipment in the prior art, when measuring the water body, the measurement data obtained is slow, and the feasibility and reliability of the obtained remote measurement of the attenuation coefficient of the water body is poorly effective.

### SUMMARY

To overcome the problems in related technologies, the disclosed embodiments of the present invention provide methods and applications of flash imaging lidar for measuring the attenuation coefficient of water bodies.

The technical solution is as follows: The flash imaging lidar uses the AFD method to measure the backscattering intensity values along the front and back edges of the range-gate in the water body, and the model of the relationship between the attenuation coefficient of the water body and the backscattering intensity is combined to obtain the attenuation coefficient of a location in the water body. The following steps are included:
Step 1, Analyze the backscattering, of different overlapping areas between the laser spot and the received field of view, introduce the overlap coefficient F, and construct an equation for the total backscattering intensity in the water body;
Step 2, Solving the horizontal distance of the target from the LIDAR system based on the constructed equation for the total backscattering intensity in the water body to obtain the differential equation;
Step 3, The obtained differential equation is used to model the relationship between the attenuation coefficient of the water body and the backscattering intensity.

In step 1, The equation for the total backscattering intensity in the water column is:

$$P = {A}_{R} cos θ {P}_{0} UF \int \frac{{e}^{- \frac{2 Cr}{cos θ}}}{{r}^{2}} dr \qquad ( 6 )$$

Where A_{R} is the effective receiving area, P₀ is the output laser optical power, half of the angle between the transmitting center axis and the receiving center axis is the θ, r is the distance of the target from the Lidar system, C is the attenuation coefficient of water bodies, U is the backscattering coefficient, F is the overlap coefficient, e≈2.7182.

In step 2, the horizontal distance of the target from the LIDAR system is solved to obtain the differential equation as:

$$\frac{{dP}_{b}}{dr} = {A}_{R} cos θ {P}_{0} UF \frac{{e}^{- \frac{2 Cr}{cos θ}}}{{r}^{2}} \qquad ( 7 )$$

Where dp_{b} is the backscattering intensity, A_{R} is the effective receiving area, P₀ is the output laser optical power, half of the angle between the transmitting center axis and the receiving center axis is the θ, r is the distance of the target from the Lidar system, C is the attenuation coefficient of water bodies, U is the backscattering coefficient, F is the overlap coefficient.

In step 3, The relationship between the attenuation coefficient of the water body and the backscattering intensity is modeled as:

$$C = - \frac{1}{2 r} cos θln \frac{\frac{{dP}_{b}}{dr} {r}^{2}}{{A}_{R} cos θ {P}_{0} UF} \qquad ( 8 )$$

Where dp_{b} is the backscattering intensity, A_{R} is the effective receiving area, P₀ is the output laser optical power, half of the angle between the transmitting center axis and the receiving center axis is the θ, r is the distance of the target from the Lidar system, C is the attenuation coefficient of water bodies, U is the backscattering coefficient, F is the overlap coefficient.

In one embodiment, the backscattering intensity values in a water body at the location of the front and back edges of the range-gate measured using the AFD method include:

The Δτ_{gate} is the width of the range-gate, Δτₛₜₒₚ is the delay step size of the flash lidar system, the imaging distance is large than R₁ which indicates F=1, the intensity image received by the ICCD is the backscattering intensity image of the full laser beam in the water body:

By assuming that the adjacent frames of the backscattering intensity images received by the lidar are k^{th} frame and k+1^{th} frame, the corresponded intensity difference image ΔI^{k} can be acquired. The pixel intensity values of both front and back edge parts in ΔI^{k} as the backscattering intensity at the corresponding distance. Assuming the backscattering intensities at the back and front edges of the range-gate are dPᵣ_{₁} and dPᵣ_{₂}:

dPᵣ_{₁}=ΣΔI_{(i,j)}^{k}, dPᵣ_{₂}=ΣΔI_{(m,n)}^{k} (9)

In an instance, obtaining the attenuation coefficient at a location in a water body includes: According to the Eq.(9) and the Eq.(8) we can get:

$$C = \frac{ln \frac{\sum Δ {I}_{( i , j )}^{k}}{\sum Δ {I}_{( m , n )}^{k}} - ln \frac{{r}_{2}^{2}}{{r}_{1}^{2}}}{2 ( {r}_{2} - {r}_{1} )} cos θ \qquad ( 10 )$$

where r₁=v(Δτ+kΔτₛₜₑₚ), r₂=v[Δτ+(k+1)Δτₛₜₑₚ], v is the light speed in the water, Δτ is the initial delay of the lidar system. C is the attenuation coefficient at a certain location in the water body.

A further object of the present invention is to provide a computer device. The computer device which is include a memory and a processor. Memory stores computer program. When the computer program executed by the processor, causes processor to perform a method for implementing the flash imaging lidar measurement of the attenuation coefficient of a water body as claimed in any one of claims 1-7.

A further object of the present invention is to provide a computer readable storage media. The computer-readable storage media stores program, when the program executed by a processor, causes the processor to perform a method of implementing any one of claims 1-7 for flash imaging lidar measurement of attenuation coefficients in a water body.

Another purpose of the invention is to provide an information data processing terminal which, when implemented on an electronic device, provides a user input interface to implement the flash imaging lidar method for measuring backward attenuation coefficient of water bodies.

Another object of the present invention is to provide a method for the application of said flash imaging lidar to measure the attenuation coefficient of a water body in liquid measurements.

Combining all of the above technical solutions, the advantages and positive effects of the present invention are: Based on the backscattering model of water bodies, this invention realizes the real-time remote sensing measurement of the attenuation coefficient of water bodies using the adjacent frame difference method. The relationship between the attenuation coefficient and the backscattering intensity of the water body was first established based on a model of the total backscattering intensity in the water body. Subsequently, the adjacent frame difference method proposed according to the present invention can measure the backscattering intensity at a location in the water body in real time, and thus obtain the attenuation coefficient of the water body. The experimental and theoretical analyses fully illustrate the feasibility of real-time remote sensing measurement of the attenuation coefficient of water bodies using the adjacent frame difference method, which has a strong practical value.

### BRIEF DESCRIPTION OF THE DRAWINGS

The accompanying figures herein are incorporated into and form part of the specification, illustrate embodiments consistent with the present disclosure, and are used in conjunction with the specification to explain the principles of the present disclosure.

FIG. 1 is a flow chart of a method for obtaining a model of the relationship between the attenuation coefficient of a water body and the backscattering intensity provided by embodiments of the present invention;

FIG. 2 is a geometrical-optical schematic diagram of the backscattering model of the spot and the water body in the received field-of-view change in the backscattering calculations provided by embodiments of the present invention;

FIG. 3 is a schematic diagram of the attenuation coefficient of water bodies using the adjacent frame difference method provided by an embodiment of the present invention.

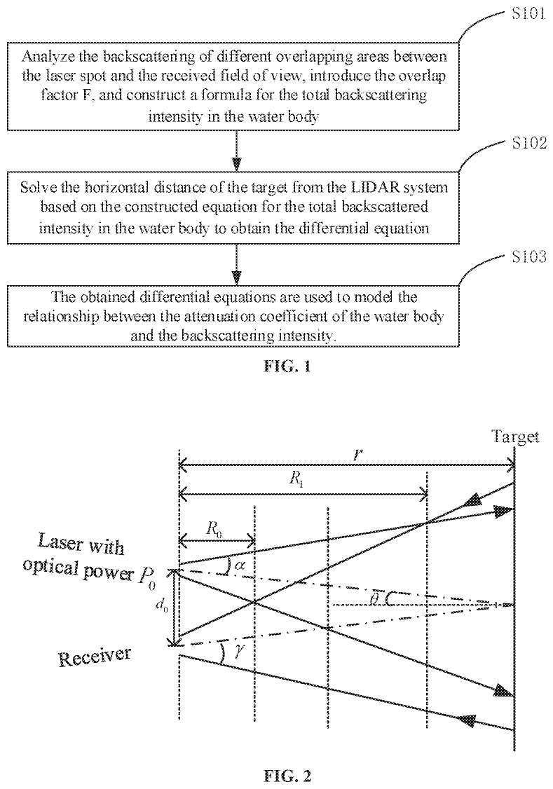

### DETAILED DESCRIPTION OF THE EMBODIMENTS

In order to make the above-mentioned objects, features and advantages of the present invention more obvious and understandable, the following detailed description of specific embodiments of the present invention is made in conjunction with the accompanying figures. Many specific details are set forth in the following description to facilitate a full understanding of the present invention. However, the present invention can be implemented in many other ways than those described herein, and similar improvements can be made by those skilled in the art without contradicting the content of the present invention, so that the present invention is not limited by the specific embodiments disclosed below.

### I. EXPLAIN THE IMPLEMENTATION EXAMPLE

### Embodiment 1

Embodiments of the present invention provide a method for measuring the backward attenuation coefficient of a water body by flash imaging lidar including the steps of:

The attenuation coefficient of a location in the water body will be obtained by combining the model of the relationship between the attenuation coefficient of the water body and the backscattering intensity along the front and back edges of the range-gate measured using the adjacent frame difference method.

### Embodiment 2

A method for measuring the attenuation coefficient of a water body by flash imaging lidar according to the method documented in Example 1, in a preferred embodiment, as shown in FIG. 1, the method of obtaining a model of the relationship between the attenuation coefficient of the water body and the backscattering intensity includes the steps of:
S101, Analyze the backscattering intensity of different overlapping areas between the laser spot and the received field of view, introduce the overlap coefficient F, and construct an equation for the total backscattering intensity in the water body;
S102, Solving the horizontal distance of the target from the LIDAR system based on the constructed equation for the total backscattering intensity in the water body to obtain the differential equation;
S103, The obtained differential equation is used to model the relationship between the attenuation coefficient of the water body and the backscattering intensity.

### Embodiment 3

A method for measuring the backward attenuation coefficient of a water body by flash imaging lidar as documented in Example 2. Where α is the half divergence angle of the laser, γ is the half field of view of the receiver, P₀ is the output laser optical power, half of the angle between the transmitting center axis and the receiving center axis is the θ, r is the distance of the target from the Lidar system, d₀ is the distance of the transmitting center and receiving center, A(r) is the irradiated area of the laser at distance of r, C is the attenuation coefficient of water bodies. The total backscattering luminous flux from the wale body can be yield as:

$$P = {A}_{R} cos θ {P}_{0} U \int \int \frac{{e}^{- \frac{2 Cr}{cos θ}}}{A ( r ) {r}^{2}} dAdr \qquad ( 11 )$$

Where U is the backward scattering coefficient, A_{R} is the effective receiving area.

The geometry sizes of the laser spot and received field-of-view interface varied with the distances between the laser source and target, which results in the changes on their overlap area. In order to analyze the backscattering with different overlap area between the laser spot and the received field of view, an overlap coefficient F is introduced, which is defined as the ratio of the laser spot area captured in the received field of view to the total laser irradiation area. Can be expressed as:

$$F = \int \frac{1}{A ( r )} dA \qquad ( 12 )$$

the angles corresponding to the overlapping area sections on the cross sections of the laser spot and received field of view are defined as ω₁ and 107 ₂, respectively. And r₁ and r₂ are the radius of the laser spot and the receiving field-of-view, respectively. d is the distance between the centers of laser spot and receiving field-of-view. The radii of the transmitting optical system and the receiving optical system are r_{L} and r_{R}, respectively. Then the detailed expression for the overlapping area at different positions can be calculated from the trigonometric relationship:

$$\{ \begin{matrix}F = 0 & ( r \leq {R}_{0} ) \\ F = 1 & ( r \geq {R}_{1} ) \\ F = \frac{{r}_{1}^{2} ( {ω}_{1} - \vert sin {ω}_{1} \vert ) + {r}_{2}^{2} ( {ω}_{2} - sin {ω}_{2} )}{2 π {r}_{1}^{2}} & ( {R}_{0} \leq r \leq {R}_{1} )\end{matrix} \qquad ( 13 )$$

The introduction of F reduces the dimension of the integral of Eq.11 and turns the double integral into an ordinary integral to simplify calculations. According to Eq.11 and Eq.12, the total backscattering flux of the water body can be further expressed as:

$$P = {A}_{R} cos θ {P}_{0} UF \int \frac{{e}^{- \frac{2 Cr}{cos θ}}}{{r}^{2}} dr \qquad ( 14 )$$

Where A_{R} is the effective receiving area, P₀ is the output laser optical power, half of the angle between the transmitting center axis and the receiving center axis is the θ, r is the distance of the target from the Lidar system, C is the attenuation coefficient of water bodies, U is the backscattering coefficient, F is the overlap coefficient, e≈2.7182.

In S102, the horizontal distance of the target from the LIDAR system is solved to obtain the differential equation as:

$$\frac{{dP}_{b}}{dr} = {A}_{R} cos θ {P}_{0} UF \frac{{e}^{- \frac{2 Cr}{cos θ}}}{{r}^{2}} \qquad ( 15 )$$

Where dp_{b} is the backscattering intensity, A_{R} is the effective receiving area, P₀ is the output laser optical power, half of the angle between the transmitting center axis and the receiving center axis is the θ, r is the distance of the target from the Lidar system, C is the attenuation coefficient of water bodies, U is the backscattering coefficient, F is the overlap coefficient.

In S103, the relationship between the attenuation coefficient of the water body and the backscattering intensity is modeled as:

$$C = - \frac{1}{2 r} cos θln \frac{\frac{{dP}_{b}}{dr} {r}^{2}}{{A}_{R} cos θ {P}_{0} UF} \qquad ( 16 )$$

Where dp_{b} is the backscattering intensity, A_{R} is the effective receiving area, P₀ is the output laser optical power, half of the angle between the transmitting center axis and the receiving center axis is the θ, r is the distance of the target from the Lidar system, C is the attenuation coefficient of water bodies, U is the backscattering coefficient, F is the overlap coefficient. only r and

$$\\ \frac{{dP}_{b}}{dr}$$

are unknown value. Therefore, the attenuation coefficient of the water body can be calculated as long as the

$$\\ \frac{{dP}_{b}}{dr}$$

and corresponding distance r been measured.

As known to those skilled in the art, the method of measuring the attenuation coefficient of a water body by the flash imaging lidar provided by embodiments of the present invention first establishes the relationship between the attenuation coefficient of the water body and the backscattering intensity value measured in real time by the adjacent frame difference (AFD) method based on the backscatter model in the water.

Essentially, both the water body backscattering light and the lidar target return light are reflected signals from different objects in the water to the incident light. Therefore, based on the principle of underwater light transmission and reflection provided by the lidar equation, a computational model of backscattering light from the water body can be developed.

### Embodiment 4

The AFD method is a new three-dimensional (3D) reconstruction algorithm based on the range-gated method. In this method, the distance information of the target at the front and back edges of the range-gated are obtained by thresholding the intensity difference between two adjacent frames achieved by the intensified-charge-coupled device (ICCD), respectively. According to the characteristics of the AFD method, it can be known that the AFD method can obtain the backscattering intensity corresponding to the front and back edges of the range-gate in real time.

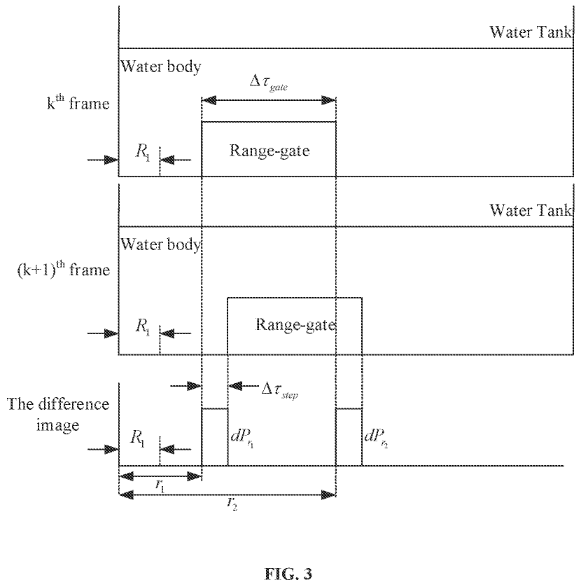

FIG. 3 presents the principal diagram of the AFD method to measure the backscattering intensity in the water. The backscattering intensity values at the front and back edges of the range-gate in the water body measured using the AFD method include the following steps:

The Δτ_{gate} is the width of the range-gate, Δτₛₜₑₚ is the delay step size of the flash lidar system, the imaging distance is large than R₁ which indicates F=1, the intensity image received by the ICCD is the backscattering intensity image of the full laser beam in the water body.

By assuming that the adjacent frames of the backscattering intensity images received by the lidar are k^{th} frame and k+1^{th} frame, the corresponded intensity difference image ΔI^{k} can be acquired. The pixel intensity values of both front and back edge parts in ΔI^{k} as the backscattering intensity at the corresponding distance. Assuming the backscattering intensities at the back and front edges of the range-gate are dPᵣ_{₁} and dPᵣ_{₂}:

dPᵣ_{₁}=ΣΔI_{(i,j)}^{k}, dPᵣ_{₂}=ΣΔI_{(m,n)}^{k} (17)

Obtaining the attenuation coefficient at a location in the water body includes: based on the Eq. (16) and Eq. (17) we can get:

$$\\ \begin{matrix}C = \frac{ln \frac{\sum Δ {I}_{( i , j )}^{k}}{\sum Δ {I}_{( m , n )}^{k}} - ln \frac{{r}_{2}^{2}}{{r}_{1}^{2}}}{2 ( {r}_{2} - {r}_{1} )} cos θ & ( 18 )\end{matrix}$$

where r₁=v(Δτ+kΔτₛₜₑₚ), r₂=v[Δτ+(k+1)Δτₛₜₑₚ], v is the light speed in the water, Δτ is the initial delay of the lidar system. C is the attenuation coefficient at a certain location in the water body.

### II. APPLICATION IMPLEMENTATION EXAMPLES

### Application Examples

Embodiments of the present invention also provide a computer device including: at least one processor, a memory, and a computer program stored in said memory and runnable on the at least one processor, the processor executing said computer program to implement the steps in any of the method embodiments described above.

Embodiments of the present invention also provide a computer-readable storage medium, the computer-readable storage medium storing a computer program, the computer program being executed by a processor to implement the steps in each of the method embodiments described above.

The embodiments of the invention also provide an information data processing terminal. The information data processing terminal is used to implement the steps in the embodiments of the methods mentioned above, and the information data processing terminal is not limited to mobile phone, computer and switch.

Embodiments of the invention also provide a server which, when implemented on an electronic device, provides a user input interface to implement the steps in embodiments of the methods described above.

Embodiments of the present invention provide a computer program product that, when the computer program product is run on an electronic device, causes the steps in each of the method embodiments described above to be implemented when the electronic device is executed.

The integrated units can be stored on a computer-readable storage medium if they are implemented as software functional units and sold or used as stand-alone products. Based on such an understanding, the present invention implements all or part of the processes in the method of the above embodiments, which may be accomplished by means of a computer program to instruct the relevant hardware, said computer program may be stored in a computer readable storage medium which, when executed by a processor, implements the steps of each of the above method embodiments. Where the computer program includes computer program code, the computer program code may be in the form of source code, in the form of object code, in the form of an executable file or in some intermediate form, etc. The computer readable medium may include at least: any entity or device capable of carrying computer program code to a photographic device/terminal device, a recording medium, computer memory, Read-Only Memory (ROM), Random Access Memory (RAM), electrical carrier signals, telecommunication signals, and software distribution media.

### III. EVIDENCE OF IMPLEMENTATION-RELATED EFFECTS

The embodiment of the present invention was compared with the average attenuation coefficient at 3-8 m in water obtained by AFD method at the delay step size of 1 ns and 2 ns and by Beer-Lambert Law by the above experiments, and the relative errors were 0.98% and 3.91%, respectively. The relative errors of the attenuation coefficients in water obtained by the AFD method at a delay step size of 1 ns are slightly smaller, which is in line with the analytical results of the present invention.

In addition, when the delay steps are 1 ns and 2 ns, respectively, the attenuation coefficients of the water bodies obtained from the fitting method are 0.1287 and 0.1232, respectively. their relative errors are 3.23% and 7.37%, respectively. The relative errors are larger compared to the AFD method. This is due to the fact that the fitting method needs to measure a sufficient number of points to ensure its accuracy, the AFD method can overcome this drawback. When the delay step is 2 ns, the relative error can be controlled to 3.91%, even though the number of measured points is only half of the number when the step is 1 ns.

TABLE 1
Comparison of Beer-Lambert Law and
AFD at different distance ranges

| | Beer-Lambert Law | | AFD method | |
|---|---|---|---|---|
| Distance (m) | C | Absolute Error | C | Absolute Error |
| 3 to 4 | 0.1133 | 6.19% | 0.1278 | 4.74% |
| 3 to 5 | 0.1206 | 0.68% | 0.1303 | 2.85% |
| 3 to 6 | 0.1152 | 4.76% | 0.1376 | 2.69% |
| 3 to 7 | 0.1262 | 3.55% | 0.1406 | 4.96% |
| 3 to 8 | 0.1330 | 8.69% | 0.1343 | 0.19% |

The relative error between the attenuation coefficients measured at different propagating distances by the AFD method with delay step time of 1 ns and Beer-Lambert Law was further compared. the relative errors for the Beer-Lambert Law are 6.82%, 0.82%, 5.26%, 3.78%, 9.38% and the relative errors for the AFD method are 4.76%, 2.89%, 2.59%, 4.82% and 0.11% in the ranges of 3-4 m, 3-5 m, 3-6 m, 3-7 m and 3-8 m. Their average relative errors are 5.21% and 3.04%. The standard deviation of the attenuation coefficient of water bodies in different distance ranges measured by the AFD method is 0.0052, which is smaller than the one from the Beer-Lambert law as 0.0083. Compared with the one for the Beer-Lambert law, it can be clearly found that the absolute errors for the AFD method does not change abruptly as the range changes. Therefore, as the measurement range increases, the AFD method is more stable than the Beer-Lambert Law. These results fully demonstrated that the attenuation coefficient of water bodies measured by AFD method in real time is feasible and credible.

The experimental results show that the present invention deduces the relationship between the backscattering intensity and the attenuation coefficient of the water body by establishing the backscattering model of the water body. And a method for remote real-time measurement of the attenuation coefficient of water bodies is proposed in combination with the adjacent frame difference method. Based on this relationship and AFD method, the attenuation coefficient of the water body can be further calculated in real time. In order to verify the feasibility of this method, the self-developed flash lidar system was used to conduct a measurement study of the fresh water body in the distance range of 3-8 m. The attenuation coefficient of the water body is measured as 0.1343±0.02 and 0.1382±0.03 under 1 ns and 2 ns delay step time of the AFD method. Theoretical analysis shows that the measurement results are more accurate for a delay step size of 1 ns. Compared these values to the one achieved following the conventional Beer-Lambert Law (0.1330±0.02), which consists well with each other. The AFD method with 1 ns delay step size has an error of about 1% compared to Beer-Lambert Law. By comparing the Beer-Lambert law and the AFD method in different distance ranges, the experimental results and theoretical analysis fully verify the feasibility and reliability of the AFD method to measure the attenuation coefficient of water bodies. A new scheme is proposed for the real-time remote measurement of attenuation coefficients in water bodies.

The above mentioned is only a specific and superior implementation of the present invention, but the scope of protection of the present invention is not limited to it. Any modification, equivalent replacement and improvement, etc. made by any person skilled in the art within the technical scope disclosed by the present invention and within the spirit and principles of the present invention shall be covered by the scope of protection of the present invention.

What is claimed is:

1. A method for measuring an attenuation coefficient of a water body by a flash imaging lidar, wherein the method uses an adjacent frame difference (AFD) method to measure backscattering intensity values along front and back edges of a range-gate in the water body, and combine a model of a relationship between the attenuation coefficient of the water body and a backscattering intensity to obtain the attenuation coefficient of the water body of a location in the water body; wherein the method comprises the following steps:
step 1, analyzing a backscattering of different overlapping areas between a laser spot and a received field of view, introducing an overlap coefficient F, and constructing an equation for a total backscattering intensity in the water body;
step 2, solving a horizontal distance of a target from a lidar system based on the equation for the total backscattering intensity in the water body to obtain a differential equation;
step 3, using the differential equation to model the relationship between the attenuation coefficient of the water body and the backscattering intensity.

2. The method for measuring the attenuation coefficient of the water body by the flash imaging lidar according to claim 1, wherein in step 1, the total backscattering intensity in the water body is given by the equation:
$$\\ \begin{matrix}P = {A}_{R} cos θ {P}_{0} UF \int \frac{{e}^{- \frac{2 Cr}{cos θ}}}{{r}^{2}} dr & ( 1 )\end{matrix}$$
wherein A_{R} is an effective receiving area, P₀ is an output laser optical power, θ is a half of an angle between a transmitting center axis and a receiving center axis, r is the distance of the target from the lidar system, C is the attenuation coefficient of the water body, U is a backscattering coefficient.

3. The method for measuring the attenuation coefficient of the water body by the flash imaging lidar according to claim 1, wherein in step 2, the distance of the target from the lidar system is solved to obtain the differential equation as:
$$\\ \begin{matrix}\frac{{dP}_{b}}{dr} = {A}_{R} cos θ {P}_{0} UF \frac{{e}^{- \frac{2 Cr}{cos θ}}}{{r}^{2}} & ( 2 )\end{matrix}$$
wherein dp_{b} is the backscattering intensity, A_{R} is an effective receiving area, P₀ is an output laser optical power, θ is a half of an angle between an transmitting center axis and a receiving center axis, r is the distance of the target from the lidar system, C is the attenuation coefficient of the water body, U is a backscattering coefficient, F is the overlap coefficient.

4. The method for measuring the attenuation coefficient of the water body by the flash imaging lidar according to claim 1, wherein in step 3, the model of the relationship between the attenuation coefficient of the water body and the backscattering intensity is:
$$\\ \begin{matrix}C = - \frac{1}{2 r} cos θ ln \frac{\frac{{dP}_{b}}{dr} {r}^{2}}{{A}_{R} cos θ {P}_{0} UF} & ( 3 )\end{matrix}$$
wherein dp_{b} is the backscattering intensity, A_{R} is an effective receiving area, P₀ is an output laser optical power, θ is a half of an angle between an transmitting center axis and an receiving center axis, r is the distance of the target from the lidar system, C is the attenuation coefficient of the water body, U is a backscattering coefficient, F is the overlap coefficient.

5. The method for measuring the attenuation coefficient of the water body by the flash imaging lidar according to claim 1, wherein the backscattering intensity values in the water body at the location of the front and back edges of the range-gate measured using the AFD method comprise:
Δτ_{gate} is a width of the range-gate, Δτₛₜₑₚ is a delay step size of the flash lidar system, F=1 if the distance of the target from the lidar system is large than R₁, an intensity image received by an intensified charge-coupled detector (ICCD) is a backscattering intensity image of a full laser beam in the water body;
by assuming that adjacent frames of the backscattering intensity images received by the lidar are k^{th} frame and k+1^{th} frame, a corresponded intensity difference image ΔI^{k} is allowed to be acquired; pixel intensity values of front and back edge parts in ΔI^{k} are as the backscattering intensity at the corresponding distance; assuming the backscattering intensities at the back and front edges of the range-gate are dPᵣ_{₁} and dPᵣ_{₂}, respectively:
dPᵣ_{₁}=ΣΔI_{(i,j)}^{k}, dPᵣ_{₂}=ΣΔI_{(m,n)}^{k} (4)

6. The method for measuring the attenuation coefficient of the water body by the flash imaging lidar according to claim 5, wherein the operation of obtaining the attenuation coefficient of the water body at the location in the water body comprises:
according to Eq.3 and Eq 4, an equation is obtained as follows:
$$\\ \begin{matrix}C = \frac{ln \frac{\sum Δ {I}_{( i , j )}^{k}}{\sum Δ {I}_{( m , n )}^{k}} - ln \frac{{r}_{2}^{2}}{{r}_{1}^{2}}}{2 ( {r}_{2} - {r}_{1} )} cos θ & ( 5 )\end{matrix}$$
wherein r₁=v(Δτ+kΔτₛₜₑₚ), r₂=v[Δτ+(k+1)Δτₛₜₑₚ], v is a light speed in the water, Δτ is an initial delay of the lidar system.

7. A computer device comprising a memory and a processor, wherein the memory stores computer program; when the computer program is executed by the processor, the processor performs the method for measuring the attenuation coefficient of the water body by the flash imaging lidar according to claim 1.

8. A computer-readable storage media storing a program, wherein when the program is executed by a processor, the processor performs the method for measuring the attenuation coefficient of the water body by the flash imaging lidar according to claim 1.

9. An information data processing terminal, wherein when the information data processing terminal is configured for an implementation on an electronic device, the information data processing terminal provides a user input interface to implement the method for measuring the attenuation coefficient of the water body by the flash imaging lidar according to claim 1.

10. The method for measuring the attenuation coefficient of the water body by the flash imaging lidar according to claim 1, wherein the method is configured in liquid measurements.

11. The computer device according to claim 7, wherein in the method, in step 1, the total backscattering intensity in the water body is given by the equation:
$$\\ \begin{matrix}P = {A}_{R} cos θ {P}_{0} UF \int \frac{{e}^{- \frac{2 Cr}{cos θ}}}{{r}^{2}} dr & ( 1 )\end{matrix}$$
wherein A_{R} is an effective receiving area, P₀ is an output laser optical power, θ is a half of an angle between a transmitting center axis and a receiving center axis, r is the distance of the target from the lidar system, C is the attenuation coefficient of the water body, U is a backscattering coefficient.

12. The computer device according to claim 7, wherein in the method, in step 2, the distance of the target from the lidar system is solved to obtain the differential equation as:
$$\\ \begin{matrix}\frac{{dP}_{b}}{dr} = {A}_{R} cos θ {P}_{0} UF \frac{{e}^{- \frac{2 Cr}{cos θ}}}{{r}^{2}} & ( 2 )\end{matrix}$$
wherein dP_{b} is the backscattering intensity, A_{R} is an effective receiving area, P₀ is an output laser optical power, θ is a half of an angle between an transmitting center axis and a receiving center axis, r is the distance of the target from the lidar system, C is the attenuation coefficient of the water body, U is a backscattering coefficient, F is the overlap coefficient.

13. The computer device according to claim 7, wherein in the method, in step 3, the model of the relationship between the attenuation coefficient of the water body and the backscattering intensity is:
$$\\ \begin{matrix}C = - \frac{1}{2 r} cos θ ln \frac{\frac{{dP}_{b}}{dr} {r}^{2}}{{A}_{R} cos θ {P}_{0} UF} & ( 3 )\end{matrix}$$
wherein dp_{b} is the backscattering intensity, A_{R} is an effective receiving area, P₀ is an output laser optical power, θ is a half of an angle between an transmitting center axis and an receiving center axis, r is the distance of the target from the lidar system, C is the attenuation coefficient of the water body, U is a backscattering coefficient, F is the overlap coefficient.

14. The computer device according to claim 7, wherein in the method, the backscattering intensity values in the water body at the location of the front and back edges of the range-gate measured using the AFD method comprise:
Δτ_{gate} is a width of the range-gate, Δτₛₜₑₚ is a delay step size of the flash lidar system, F=1 if the distance of the target from the lidar system is large than R₁, an intensity image received by an intensified charge-coupled detector (ICCD) is a backscattering intensity image of a full laser beam in the water body;
by assuming that adjacent frames of the backscattering intensity images received by the lidar are k^{th} frame and k+1^{th} frame, a corresponded intensity difference image ΔI^{k} is allowed to be acquired; pixel intensity values of front and back edge parts in ΔI^{l} are as the backscattering intensity at the corresponding distance; assuming the backscattering intensities at the back and front edges of the range-gate are dPᵣ_{₁} and dPᵣ_{₂}, respectively:
dPᵣ_{₁}=ΣΔI_{(i,j)}^{k}, dPᵣ_{₂}=ΣΔI_{(m,n)}^{k} (4).

15. The computer device according to claim 14, wherein in the method, the operation of obtaining the attenuation coefficient of the water body at the location in the water body comprises:
according to Eq.3 and Eq 4, an equation is obtained as follows:
$$\\ \begin{matrix}C = \frac{ln \frac{\sum Δ {I}_{( i , j )}^{k}}{\sum Δ {I}_{( m , n )}^{k}} - ln \frac{{r}_{2}^{2}}{{r}_{1}^{2}}}{2 ( {r}_{2} - {r}_{1} )} cos θ & ( 5 )\end{matrix}$$
wherein r₁=v(Δτ+kΔτₛₜₑₚ), r₂=v[Δτ+(k+1)Δτₛₜₑₚ], v is a light speed in the water, Δτ is an initial delay of the lidar system.

16. The computer-readable storage media according to claim 8, Wherein in the method, in step 1, the total backscattering intensity in the water body is given by the equation:
$$\\ \begin{matrix}P = {A}_{R} cos θ {P}_{0} UF \int \frac{{e}^{- \frac{2 Cr}{cos θ}}}{{r}^{2}} dr & ( 1 )\end{matrix}$$
wherein A_{R} is an effective receiving area, P₀ is an output laser optical power, θ is a half of an angle between a transmitting center axis and a receiving center axis, r is the distance of the target from the lidar system, C is the attenuation coefficient of the water body, U is a backscattering coefficient.

17. The computer-readable storage media according to claim 8, wherein in the method, in step 2, the distance of the target from the lidar system is solved to obtain the differential equation as:
$$\\ \begin{matrix}\frac{{dP}_{b}}{dr} = {A}_{R} cos θ {P}_{0} UF \frac{{e}^{- \frac{2 Cr}{cos θ}}}{{r}^{2}} & ( 2 )\end{matrix}$$
wherein dp_{b} is the backscattering intensity, A_{R} is an effective receiving area, P₀ is an output laser optical power, θ is a half of an angle between an transmitting center axis and a receiving center axis, r is the distance of the target from the lidar system, C is the attenuation coefficient of the water body, U is a backscattering coefficient, F is the overlap coefficient.

18. The computer-readable storage media according to claim 8, wherein in the method, in step 3, the model of the relationship between the attenuation coefficient of the water body and the backscattering intensity is:
$$\\ \begin{matrix}C = - \frac{1}{2 r} cos θ ln \frac{\frac{{dP}_{b}}{dr} {r}^{2}}{{A}_{R} cos θ {P}_{0} UF} & ( 3 )\end{matrix}$$
wherein dp_{b} is the backscattering intensity, A_{R} is an effective receiving area, P₀ is an output laser optical power, θ is a half of an angle between an transmitting center axis and an receiving center axis, r is the distance of the target from the lidar system, C is the attenuation coefficient of the water body, U is a backscattering coefficient, F is the overlap coefficient.

19. The computer-readable storage media according to claim 8, wherein in the method, the backscattering intensity values in the water body at the location of the front and back edges of the range-gate measured using the AFD method comprise:
Δτ_{gate} is a width of the range-gate, Δτₛₜₑₚ is a delay step size of the flash lidar system, F=1 if the distance of the target from the lidar system is large than R₁, an intensity image received by an intensified charge-coupled detector (ICCD) is a backscattering intensity image of a full laser beam in the water body;
by assuming that adjacent frames of the backscattering intensity images received by the lidar are k^{th} frame and k+1^{th} frame, a corresponded intensity difference image ΔI^{k} is allowed to be acquired; pixel intensity values of front and back edge parts in ΔI^{k} are as the backscattering intensity at the corresponding distance; assuming the backscattering intensities at the back and front edges of the range-gate are dPᵣ_{₁} and dPᵣ_{₂}, respectively:
dPᵣ_{₁}=ΣΔI_{(i,j)}^{k}, dPᵣ_{₂}=ΣΔI_{(m,n)}^{k} (4).

20. The computer-readable storage media according to claim 19, wherein in the method, the operation of obtaining the attenuation coefficient of the water body at the location in the water body comprises:
according to Eq.3 and Eq 4, an equation is obtained as follows:
$$\\ \begin{matrix}C = \frac{ln \frac{\sum Δ {I}_{( i , j )}^{k}}{\sum Δ {I}_{( m , n )}^{k}} - ln \frac{{r}_{2}^{2}}{{r}_{1}^{2}}}{2 ( {r}_{2} - {r}_{1} )} cos θ & ( 5 )\end{matrix}$$
wherein r₁=v(Δτ+kΔτₛₜₑₚ), r₂=v[Δτ+(k+1)Δτₛₜₑₚ], v is a light speed in the water, Δτ is an initial delay of the lidar system.
